(19) United States
(12) Patent Application Publication
(10) Pub. No.: US 2008/0268395 A1
(43) Pub. Date: Oct. 30, 2008

(54) Method and Device for Pulse Heat Treatment of Bulk Materials

(76) Inventors: Viktor Semenovich Lahmostov, Novosibirsk (RU); Yury Yuryevich Tanashev, Novosibirsk (RU); Dmitrii Nikolaevich Sokolov, Novosibirsk (RU); Vladimir Vladimirovich Danilevich, Novosibirsk (RU); Iliya Aleksandrovich Zolotarskii, Novosibirsk (RU); Valentin Nikolaevich Parmon, Novosibirsk (RU)

Correspondence Address: LADAS & PARRY LLP, 26 WEST 61ST STREET, NEW YORK, NY, 10023, US

(21) Appl. No.: 10/594,648

(22) PCT Filed: Mar. 28, 2005
(86) PCT No.: PCT/RU2005/000139

§ 371 Date: Jul. 2, 2008

(30) Foreign Application Priority Data
Apr. 1, 2004 (RU) 2004109970

(51) Int. Cl. C10B 21/20; F27D 15/02

(52) U.S. Cl. 432/31; 432/85

(57) ABSTRACT

The invention relates to a method and devices for short-time heat treatment and/or quenching of bulk materials and can be used for the chemical, food, wood and other industries. The inventive method for a pulse heat treatment of bulk materials consists in evaporating surface moisture, rapidly heating to a required temperature and in subsequently cooling by supplying particles to a rotating surface whose temperature is greater than 100° C., wherein the contact of particles with the hot surface is carried out by means of centrifugal forces, the time of contact and a pressure force are controlled by modifying the speed of rotation of the hot surface and the particle quenching stage is carried out on a cooling plate by the rapid cooling said particles and collecting a final product in an accumulator. The treatment of moving bulk material particles is carried out on the rotatable cylindrical or conical hot surface on which an excessive moisture evaporating stage and stage for heating to the required temperature are combined. The time of the material displacement along the hot surface by the gravity force are controlled by a friction force which is adjustable by modifying the speed of rotation. A device for carrying out said method is also disclosed.

### BACKGROUND OF THE INVENTION

The invention relates to a method and devices for short-time heat treatment and/or quenching of bulk materials and can be used at the stage of thermochemical activation in producing catalysts, carriers, adsorbents, dehydrators, fillers, ceramics, magnetic materials, inorganic pigments, solid electrolytes, medical and cosmetic preparations, etc., in processes of drying/cooling in chemical, food, woodworking and other industries.

A method for activating crystalline oxygen-containing compounds by quick heating at the rate of hundreds and thousands degrees/minute of powder particles due to their contact with gas flow, for example smoke fumes, or solid heat carrier (the method for thermochemical activation/TCA/) is known (SU 517564, C01F7/30, 1975; SU 967028, C01F7/02, 1981; RU 2064435, C01F7/44, 1994). Such heating results in formation of decomposition products having valuable chemical properties. Products of activation are subjected to cooling-quenching at an outlet from a hot zone for fixation of amorphous state. The disadvantages of this method are dust-laden gas emissions containing hazardous admixtures (NOₓ, SOₓ, CO, hydrocarbons), contamination of initial substances by fuel admixtures and products of incomplete burning, relatively long time required for cooling-quenching process (10 minutes up to temperature 60° C.) and low efficiency of using energy of heat carriers leading to high specific power inputs.

An analogous method for heat treatment of initial of bulk materials is its heating by moving along the surface of a vibrating groove in the field of radiation gas burners at a temperature from 400 to 600° C. for 5-30 s (SU 528733, C01F7/44, 1973). Heating due to heat transfer in contact of initial material particles with hot metal is more effective than heating particles through their contacts between themselves or due to convective heat exchange in hot air flow. The disadvantage of the known method is relatively low speed of material movement along the groove and difficulties in providing uniform distribution of initial bulk material along the heated surface of the groove due to its vibration. This disadvantage is practically impossible to overcome when attempting to increase the size of the groove for achieving output of more than 2 kg/hour.

Similar technical solution is an installation for pulse heat treatment of bulk materials (patent RU 2115634, C04B35/52, 20 Jul. 1998). The installation comprises a tank for an initial material, heaters and a drive for rotation. In the patent a method for pulse heat treatment of bulk materials is also disclosed; the method comprises feeding, distributing and moving initial material along a heated surface wherein particles of the material are in relative motion and contact, and discharge of finished product in a storage accumulator.

A device and a method for pulse heat treatment of bulk materials are a most similar to the present invention (patent RU 2186616, 7 B01J8/10, 10 Aug. 2002).

The invention according to the closest prior art solves the following problems:

controlling flow rate of bulk materials; even and dense distributing along a heated surface; increasing the rate of heating a bulk material tights; fast cooling-quenching of the thermal treatment product for fixing a metastable structure; increasing productivity; decreasing power consumption.

The above problems are solved by using the method of pulse heat treatment of bulk materials including feeding, distribution and movement along a heated surface of initial material with particles being in relative displacement and contact; discharge of the finished product in a storage reservoir. After feeding the initial material is mixed and at the same time heated, then it is metered, evenly distributed and moved along rotating surface heated to 100-1500° C., superheated vapor is bled off, and at the moment of leaving the heated surface the product is quenched.

Relative movement of the material and contacts of the particle with then heated surface are due to centrifugal force, and the time of the contact and the force of pressing material against the heated surface are controlled by the speed of rotation. Heating of the initial material particles is due to heat transfer during the contact with the plate. In addition to gravity the compression of particles due to the centrifugal force increases the tightness of their contact with the operative heated surface of the plate and enhances the heat transfer process. Such method of heating provides for increased speed of particle relative movements thereby increasing productivity of the process.

Quenching at the moment when product leaves the heated surface is provided by contact with cooled side surface of the device. The product is cooled to a temperature of at most 150° C. for not more than 5 s. The process of heating-quenching takes 0.5 to 5.0 s. Vapor is extracted in the plate zone at a maximum pressure of superheated vapor. For metering bulk material the metering gap area is controlled. In metering the flow rate of the bulk material remains constant when the number of plate turns is changed.

Objectives according to the closest prior art are achieved by using a device for pulse heat treatment of bulk materials, the device comprising a vertical shaft with a drive and attached plate mounted in a housing; a tank for an initial material with a flow rate regulator in the lower part; a storage enclosure. The device is equipped with heaters, a superheated steam evacuation system, a cooling-quenching system for the products of pulse heat treatment, wherein the operational (upper) surface of the plate is conical or has a curvature providing upward widening.

The plate heater can be placed on the plate or above it. The heat sources are electric heaters, gas or other fuel burners. The heater is secured in thermally insulated base of the device housing. The upper part of the thermally insulated housing of the device is designed to be displaced in axial direction forms a slot with the operational surface of the plate; said slot transforms into a cooling zone. The cooling zone for the product of pulse heat treatment is a cavity defined by the side housing and the bottom surfaces of the device. The side housing and the bottom surfaces are subjected to forced cooling. The cooling zone is connected with the inside of the storage for collecting product. The side surface of the device housing is conical or has another shape narrowing downwards. Initial material flow rate regulator is a movable in axial direction bushing interacting with conical (or of another shape) portion extending in the feeding surface of the plate. The storage for the initial bulk material is equipped with a heater. The slot between the plate and the upper part of the housing is connected with the cavities for evacuated superheated vapor and for heating the storage for initial product.

The axial moves of the flow rate regulator between the bushing lower end and a conical part of the vertical shaft allows controlling bulk material flow rate.

The side surface of the bottom and the side surface of the housing define the cooling cavity and they are provided with a system of cooling liquid supply. The cooling cavity transforms into a conical cavity of the product storage.

The known solution has the following disadvantages: low effectiveness of impulse heat treatment of bulk materials due to complicated configuration of the heat carrier (the plate) which does not provide for uniform distribution of treated material on the heated surface. Moreover, the known device is highly inertial in terms of heating/cooling. In case of heavy thermal insulation of the housing and a large size of the plate (a diameter of 1 m and thickness of 1 cm), the time required for heating from 20 to 300° C. is about 1 hour when the power of heaters is 50 kW. In case of halting operations of the device according to the prior art it can be opened only after cooling the plate for a few hours. What is more during the process of heating/cooling the plate must continue rotation to avoid skewing.

### SUMMARY OF THE INVENTION

It is an object of the present invention to solve the problem of enhancing effectiveness of bulk material pulse heat treatment.

The present invention offers a method for pulse heat treatment of powdered bulk materials practically free of the disadvantages of the closest prior art and other analogues due to optimal method of treatment with the same result but at lower temperatures allowing the use of a wide range of high-temperature and corrosion-resistant materials for the rotating heated surface and of centrifugal activator of simple design. What is more, it becomes possible to treat in one step both dry and wet bulk materials. It makes the treatment method economical and competitive. As the treatment process for wet materials is more complex than for dry materials, further description is focused on processing wet materials. The method and device for treatment of dry material are similar but the method is simpler and carried out according to specially selected modes.

### DESCRIPTION OF THE DRAWINGS

FIG. 1—A device for pulse heat treatment of bulk materials

### DETAILED DESCRIPTION OF THE INVENTION

The object is accomplished by using the claimed method and device for implementing thereof.

The method of pulse heat treatment of bulk materials comprises the following steps: evaporation surface moisture; fast heating to a required temperature and consequent cooling with simultaneous feeding particles on a rotating surface heated to a temperature above 100° C., contacting particles with the heated surface under the action of centrifugal force wherein the contacting time and pressure of the particles against the surface are controlled by changing the speed of rotation; and the step of quenching particles on the surface of a cooler by fast cooling an then collecting the finished product in the storage.

Treatment of moving bulk material particles is carried out on the surface of a truncated cone or a cylinder rotating around a vertical axis, and the steps of vaporization and heating to a required temperature are combined. Time of motion of the material on the heated surface under gravity is controlled by the friction force and the friction force is controlled by changing the speed of rotation.

A bulk material having moisture content of 5.0 wt % is fed in the form of extrusion granules. The process of pulse heat treatment is carried out on the inner surface of a dram having the shape of a vertically rotating cylinder or a truncated cone, and the material is fed from above. The time of treated material movement on the rotating heated surface increases when the speed of rotation is increased. Under the condition that the time of contact is predetermined the productivity of the activator is increased if the diameter of the drum is increased and the speed of rotation is decreased. Depending on the drum diameter selected for determined productivity the initial material is fed on one or a few sectors of a distributing ring from above. The number of sectors depends on the area of distribution along the surface of the drum without overlapping of the distribution areas. The quenching step is carried out on the surface of the cooler located below the drum by rapid cooling in not more than 3 s to a temperature not higher than 150° C. Total treatment time at all steps is not less that 1 s.

A method of pulse heat treatment of powdered bulk materials comprises: feeding wet material with moisture content of up to 20 wt %, removal of surface moisture from particles with simultaneous heat pulse on the rotating surface heated to a temperature higher than 100° C.; consequent rapid quenching by cooling to a temperature not higher than 150° C. for not longer than 3 s, and collecting the finished product in a storage. There are the following requirements for conducting the steps of this method:

1. The wet material is fed in the form of not very strong microgranules having a diameter of up to 3 mm produced by any known process (for example, by extrusion on a screw type extruder). The granules moves along a groove in the mode of broken flow (to avoid blockage due to hang-ups) to the heated rotating surface.

2. Contact of wet granules with the surface heated to 600-700° C. results in their immediate heating and breakage by vapor of moisture evaporating from the surface of the particles since the bonds (adhesion) between particles in granules is not strong. Tests has shown that for breaking granules having a diameter of up to 3 mm it is enough to let them fall from the groove arranged at some height on the heated rotating surface. The duration of evaporation and heat pulse is about 1 s.

Thus this process provides for continuous treatment of wet material in one step with the heat pulse.

3. In the claimed method as well as in the closest prior art the basic part is treatment of particles on a rotating heated surface in the field of action of gravitational and centrifugal forces but the difference of the claimed method is in that gravitational forces have determining influence on the particle movements along the heated surface and centrifugal forces provide for creation of friction on the surface, and friction controls the speed of powder motion, i.e. it controls the time of contacts. The weight of powder material does not depend on the shape of contact surfaces, and centrifugal forces always acting in one direction perpendicular to the axis of rotation are practically the same in such contacts. It means that such resolution of forces can be achieved not on a horizontal surface but on a vertical one in a shape of cylindrical drum of corresponding height feeding particles on the inside surface from above. As the centrifugal forces are perpendicular to the surface and commensurable with the particle weight, the force pressing them against the drum and the speed of their sliding is easy to control changing the speed of drum rotation, and the centrifugal force determining the time of particle contact is constant for any cylindrical surface.

It is known that the formula of centrifugal force is F_{c}=mω²r where is a particle mass, ω is an angular velocity (turning speed) and r is a radius of drum circumference. If values of F_{c} and m are constant, an increase in r should be followed by a decrease in ω=2πn, i.e. a decrease in number of turns n per unit of time.

Thus use of centrifugal force not contrary to gravitational force leads to a positive result: with increase of the drum diameter and simultaneous decrease its speed of rotation the action of the gravitational forces and centrifugal force on particles remains the same. Therefore the productivity of centrifugal activators depends only on the size of the drum and its number of turns: the bigger is drum diameter, the lower is the number of turns. It is reasonably reliable solution for a design. It also allows flexible control over the process for treatment of bulk materials with wide range of parameters. Choice of drum size is limited by its surface area required for heat transfer of determined amount of heat from heaters and their arrangement in the drum of big size.

4. Material is fed uniformly on one or a few sectors (depending on the diameter of the drum chosen for required productivity) in the upper part of the drum. If there are a few places of supply, each particle flow slides on the surface along a helical curve and scatters along the surface of the quenching cooler in sectors of certain length when leaving the edge of the drum. There should be no overlapping of these sectors if there is no overlapping when dissipating along the drum surface. It determines the number of points for powder feed at the beginning.

5. The design of the drum is very simple and can be produced from thin sheets quick to be heated (it is important at start of an activator) and cooled down at stops. Material for the dram can be any heat-resistant stainless steel. A drum can be quickly replaced when worn-out.

6. After leaving the hot surface the material is quenched due to contact with the surface of a cooler. Cooling is controlled by regulating supply of a refrigerant. The product is cooled to a temperature not higher than 150° C. in not more than 3 s.

7. The complete process of evaporating-heating-quenching of bulk material particle is carried out in the wide range of time. It can be a short-time treatment for 0.5-1.0 s as well as longer one for more than 1 s. Temperature is controlled by zones with the help of thermocouples placed in zones of the heater, product storage, inlet and outlet of refrigerant and outlet of vapor.

The inventive method is implemented using a device, a centrifugal activator, for pulse heat treatment of bulk materials. The device comprises a vertical console shaft arranged in a housing with a remote electric drive for its rotation, one end on the shaft is mounted in a housing cover in cooled bearing box; one or more ducts for feeding the initial material on the rotating surface; a surface for pulse heat treatment in the shape of vertical cylindrical or conical drum; a unit of cooling-quenching the product after pulse heat treatment; and a storage unit for the product. The activator is equipped with heaters of the drum and a unit for discharging superheated vapor.

The heater can be arranged outside and/or inside the drum. Electric heaters in heat-insulating housings are used. The unit of cooling-quenching the product is a cylindrical quenching cooler consisting of one or more cooling chambers with individual control of refrigerant supply in each chamber. The storage unit is an extension of the cooler body with an annular slot of 2-3 mm between them for avoiding heat transfer between the housings of the cooler and the storage. If such slot is not arranged, the storage upper part can be cooled resulting in particle sticking to it. The storage has a distribution ring arranged outside with openings into its zone.

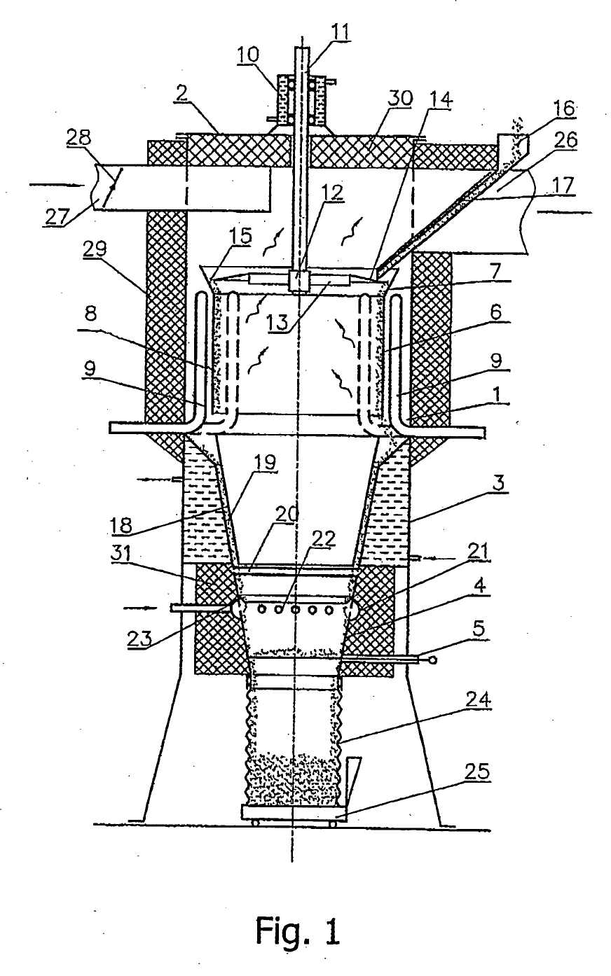

The method for treatment of bulk materials is realized in the device, the centrifugal activator, shown on FIG. 1 for two variants of the design: one with a conical rotatable drum 8 shown to the left from the axis, and the other with a cylindrical drum 6 shown to the right. The activator comprises body 1 with removable cover 2, quenching cooler 3, storage 4 with locking means 5 of a gate type, cylindrical rotatable drum 6 with conical collar 7 or conical drum 8 with electric heaters 9 mounted outside and/or inside (shown in a dotted line) of the drums. Electrically driven (not shown in the FIGURE) shaft 11 is fixed in cooled bearing housing 10, the housing is mounted on activator. At the lower end of shaft 11 distribution ring 14 is arranged on hub 12 with the help of ribs 13. There is gap 15 between drum 6, 8 and ring 14. The bulk material fed through duct 16 having cover 17 to distribution ring 14 is thrown to rotatable drum 6, 8 through gap 15. Quenching cooler 3 consisting of a few chambers separated by solid partitions (one chamber is shown in the FIGURE) is mounted under drum 6, 8 with the electric heaters. Each chamber has an inlet and outlet for the refrigerant. The cooler is protected by metal screen 18 from inside. The screen is arranged with gap 19 of 5-7 mm for free sliding of particles on the surface of cooler 3. Storage 4 is located below cooler 3 so that there is gap 20 between them. The storage is fixed to the cooler by ribs. Distribution collector 21 with openings 22 and air inlets is provided at the outer side of the storage. The holes are protected by shield 23. Detachable packaging 24 (a polyethylene bad, etc.) is fixed to the storage and placed on floor scales 25. There is outlet tube 26 in the upper part of housing 1 for discharging overheated vapor equipped with a ventilator. Opposite to it there is inlet tube 27 with controllable gate 28 for supplying air to shaft 11 for its additional cooling. Housing 1 has thermal insulation 29, cover 2 has thermal insulation 30 and storage 4 has thermal insulation 31.

The device is operated in the following way.

At first a refrigerant is filled in quenching cooler 3 and in bearing housing 10 and fix packaging 24 from the bottom. Then drum 6, 8 is heated by electric heaters 9 to predetermined temperature. At the next step the drive of shaft 11 is switched on, the ventilator at the vapor outlet is switched on, and granules of wet bulk material flow is directed through duct 26 to rotating distribution ring 14. Under the action of centrifugal force the particles of the bulk material are pressed to the inner surface of the drum and move downwards in rotational-translational motion along a trajectory of a helical curve. The particles are under the action of a vertical gravitational force and friction force controlled by a centrifugal force (a number of turns). The frictional force determines the speed of particle sliding along the surface thereby providing predetermined time of contact. When leaving the drum lower edge, the powder retains its acquired circumferential component of speed and falls on the conical surface of quenched cooler 3. Wet vapor escaping from particles is removed through the central opening of distribution ring 14 and further through outlet tube 26.

The material further slides along the surface of cooler 3 at a temperature controlled by refrigerant supply and cools to a required temperature.

The zone of storage 4 is a continuation of the zone of cooler 3. There is gap 20 (3-5 mm) between the zones for preventing cooling of the storage upper part from the cooler and particle sticking in the zone. Then the product accumulates in storage 4 on gate 5 (closed) and eventually poured into packaging 24. After the packaging is filled to certain weight fixed by floor scales 25, storage 4 is closed with gate 5 while the packaging is replaced.

Outside air is supplied through inlet tube 27 for additional cooling of shaft 11 (basic cooling is in housing 10). The air is either removed by the vapor ventilator or forced in case vapor is evacuated through a hood depending on the mode of operation.

During operation in some modes dry air for partial ventilation of the inner part of the activator is supplied through openings 22 in distribution collector 21.

Further the invention is illustrated with the following examples:

### EXAMPLE 1

A wet powder of technical alumina hydrate Al(OH₃) (mudstone) comprising particles having sizes between 0-150 μm and moisture of 17 wt % after being discharge from a screw extruder in the form of granules of 2-3 mm is continuously fed along an inclined groove in the rotating drum of 200 mm in diameter heated to a temperature of 650° C.±10° C. The powder is fed in one point of the distribution ring in the amount of 5 kg/h. The gap between the drum and the distribution ring is 5 mm. The speed of rotation is determined experimentally at 90 rev/min providing for the contact of the powder with the drum operational surface for about 1 s. The flow rate of water in the cooling system of the quenching cooler is 150 l/h, 50 l/h per each chamber. Power consumption of the device is 6.8 kW. After cooling the powder passes into a storage bin. The amount of the activated product in the storage bin is 4.2 kg after one hour of operation. X-ray phase analysis shows that the product of the heat treatment has an amorphous structure and enhanced reactivity revealed by a speed of dissolving in an alkali that is 5 times higher that for the initial substance. The initial substance—aluminum (III) hydroxide—is present in the product in the amount less than 5%.

### EXAMPLE 2

Example 2 is similar to Example 1. The difference is only in that a preliminary dried non-granulated powder of mudstone is treated. The gap between the ring and the drum is 2 mm. The result of the heat treatment of the particles is the same as in Example 1, and the initial substance is present in the product in the amount not more than 3%.

1. A method for pulse heat treatment of bulk materials comprising steps of evaporating surface moisture, fast heating to a required temperature and consequent cooling wherein particles are fed on a rotating surface heated to a temperature higher than 100° C., the contact of the particles with the heated surface is due to centrifugal forces; the time of the contact and the force pressing particles against the surface are controlled by changing the speed of rotation; and a step of quenching is carried out on the surface of a cooler by fact cooling and collecting the finished product in a storage, characterized in that the treatment of moving particles of a bulk material is carried out on a vertical cylindrical or a vertical conical surface wherein the steps of evaporating excess moisture and heating to a required temperature are combined; the time of material moving along the heated surface under the action of gravitational force is controlled by frictional force, and the frictional force is regulated by changing the speed of rotation.

2. A method according to claim 1, characterized in that the bulk material having a moisture content of not more than 5.0 wt % is fed in the form of extrusion granules.

3. A method according to claim 1, characterized in that the pulse heating is carried out on the inner surface of the vertical rotating drum of a cylindrical or conical shape with the material being fed at the upper end of the drum from above.

4. A method according to claim 1, characterized in that the time of movement of the treated material along the rotating heated surface is increased with an increase in the speed of rotation.

5. A method according to claim 3, characterized in that the productivity of an activator under the condition of a predetermined contact time is increased by increasing the drum diameter with simultaneous decreasing the speed of rotation.

6. A method according to claim 1, characterized in that depending on the diameter of a drum selected for certain productivity the initial material is fed on one or more sectors of the distributing ring from above, wherein the number of the sectors depends on spreading the material on the drum surface without areas of spreading overlapping each other.

7. A method according to claim 1, characterized in that the quenching step is carried out on the surface of the cooler arranged below the drum by fast cooling to a temperature not higher than 150° C. for not more than 3 s.

8. A method according to claim 1, characterized in that the total time of the treatment at all stages is not less than 3 s.

9. A device for pulse heat treatment of bulk materials, said device comprising a thermally insulated housing with a cover; a vertical shaft with an electric drive; a surface fixed to the shaft and heated by attached heating elements; a unit for metered feeding of an initial material and water vapor withdrawal; and a quenching cooler and a storage in the lower part of the housing, characterized in that a hollow drum with a distribution ring is mounted on the vertical rotatable shaft below on a hub, said shaft is arranged in a cooled housing with bearings placed on the cover; there is a gap between the ring and the drum; an initial bulk material is fed in the gap zone through one or more inclined ducts.

10. The device according to claim 9, characterized in that the heating elements are located outside and/or inside the drum.

11. The device according to claim 9, characterized in that the diameter of the distribution ring is smaller than the drum diameter by the size of a gap of 2-5 mm and is inclined to the drum at an angle from 0 to 30° to horizontal line.

12. The device according to claim 9, characterized in that the drum, the distribution ring and the hub are connected by ribs forming a solid unit.

13. The device according to claim 9, characterized in that the surface of the quenching cooler is conical with inclination downwards or cylindrical with a conical widening at the top.

14. The device according to claim 9, characterized in that the quenching cooler is divided inside by solid partitions along its height into two or more sections with inlet and outlet connecting tubes for a refrigerant in each section.

15. The device according to claim 14, characterized in that the surface of the cooler inside a chamber is protected by a parallel screen along the whole height.

16. The device according to claim 9, characterized in that the wall of the storage is an extension of the inner cooler wall, it has outside heat insulation and a gap between the walls to avoid heat transfer between them.

17. The device according to claim 9, characterized in that there is a distribution ring outside the storage wall with openings into the storage; said openings have a protecting collar from above.

18. The device according to claim 9, characterized in that there is an outlet tube for removing superheated vapor, said tube is located under the cover and connected to the ventilator.

19. The device according to claim 18, characterized in that opposite to said outlet tube an inlet tube with controllable gate is arranged for supplying air for partial cooling of the shaft and/or for controlling pressure in the activator.

20. The device according to claim 18, characterized in that a blocking the outlet metering device with a drive is arranged in the lower zone of the storage.
